(19) United States
(12) Patent Application Publication
(10) Pub. No.: US 2024/0218910 A1
(43) Pub. Date: Jul. 4, 2024

(54) WET DISK BRAKE WITH EXTERNAL OILING

(71) Applicant: Schaeffler Technologies AG & Co. KG, Herzogenaurach (DE)

(72) Inventors: Christian Denda, Achern (DE); Benjamin Baerwald, Kuppenheim (DE)

(73) Assignee: Schaeffler Technologies AG & Co. KG, Herzogenaurach (DE)

(21) Appl. No.: 18/020,657

(22) PCT Filed: Aug. 4, 2021
(86) PCT No.: PCT/DE2021/100670

§ 371 Date: Jun. 21, 2023

(30) Foreign Application Priority Data
Aug. 13, 2020 (DE) 10 2020 121 310.7

(51) Int. Cl. F16D 65/12; F16D 55/36; F16D 65/02

(52) U.S. Cl. CPC F16D 65/128; F16D 65/127; F16D 55/36; F16D 2065/1324; F16D 2065/1328

(57) ABSTRACT

The invention relates to a wet disk brake with external oiling of a friction surface (34), having a circumference.

To improve the cooling of the disk brake with external oiling and to minimize drag losses, the friction surface (34) has a zigzag-shaped or undulating groove running around the circumference or a groove (2) running tangentially around the circumference.

The invention relates to a wet disk brake with external oiling having the features of the preamble of claim 1.

The scope of application of the invention: Wet disk brakes in hybrid modules, DHT and shiftable e-axles, low-loss disk brakes as starting, shifting and separating elements.

Wet disk clutches and brakes are widely used in conventional power-shift transmissions, in innovative hybrid modules in heavy-duty drivetrains or in shiftable e-axles, and they represent high-performance, heavy-duty components. The demands for lower CO2 emissions and improved efficiency of drivetrains in automotive applications are of great importance. In addition to reducing load-independent losses in shifting elements, the thermal load and adequate cooling must be taken into account. The groove pattern of the friction disk plays a central role in the trade-off between friction characteristics, heat management and efficiency.

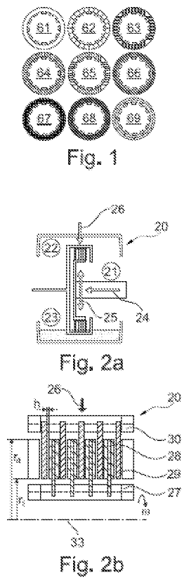

### PRIOR ART (FIG. 1)

DE 20 2015 009 048 U1 and U.S. Pat. No. 8,474,590 B2 show a wet-running friction part with grooves in the friction surface.

Disadvantage: Particularly in the case of disk brakes and external oiling (see FIG. 2), tried and tested groove patterns (for internal oiling) cannot be used.

The invention is therefore based on the object of improving the convective cooling/cooling effect and minimizing drag losses in disk brakes with external oiling by means of a suitable groove pattern.

The object is achieved by a wet disk brake with external oiling having the features according to claim 1.

The wet disk brake according to the invention with external oiling thus provides that the friction surface has a zigzag-shaped or undulating groove running around the circumference or a groove running tangentially around the circumference.

In the case of disk brakes with external oiling, such a groove pattern improves the cooling effect and reduces drag losses.

The above-stated object is achieved with a wet disk brake with external oiling of a friction surface with a circumference in that the friction surface has a zigzag-shaped or undulating groove running around the circumference or a groove running tangentially around the circumference. The friction surface is advantageously provided on a friction disk, which preferably has a corresponding friction surface on each of two opposite sides. The friction surface is represented, for example, with the help of pieces of friction lining, which are also referred to as pads. The friction lining pieces or pads are attached to a carrier element, for example glued to a carrier plate. The shape and arrangement of the friction lining pieces produce grooves in a defined groove pattern in the friction surface. In addition to the circumferential groove, the groove pattern comprises further grooves through which a cooling and/or lubricating medium, in particular oil, gets into the circumferential groove from the outside.

A preferred exemplary embodiment of the wet disk brake is characterized in that inlet grooves, through which oil enters the circumferential groove from the outside, each have a widening radially on the outside relative to the friction surface. The widening improves the oil supply from the outside, especially when the disk brake is closed. In this context, widening means in particular that the respective inlet groove widens outwards in the radial direction. Viewed in the circumferential direction, the inlet groove has a greater width radially on the outside than radially on the inside. The increase in the width of the inlet groove from radially inside to radially outside preferably happens continuously, for example constantly. The widening can be provided over the entire radial extent of the inlet groove. However, it is also possible that only a radially outer area of the inlet groove is provided with the widening.

Another preferred exemplary embodiment of the wet disk brake is characterized in that friction lining pieces which delimit the circumferential groove radially on the outside and the inlet grooves in the circumferential direction are trapezoidal in shape in order to constitute a diffuser-like widening of the inlet groove. This effectively improves the supply of oil through the inlet grooves into the circumferential groove.

Another preferred exemplary embodiment of the wet disk brake is characterized in that friction lining pieces which delimit the circumferential groove radially on the outside and the inlet grooves in the circumferential direction have bevels or chamfers facing one another in the circumferential direction in order to create a funnel-like widening of the inlet groove radially on the outside. The claimed wet disk brake can have only friction lining pieces with bevels or chamfers to create a uniform groove pattern that includes only inlet grooves with funnel-like widenings. However, the friction lining pieces with the bevels or chamfers can also be combined with the trapezoidal friction lining pieces or with differently shaped friction lining pieces in order to create a groove pattern with differently shaped inlet grooves.

A further preferred exemplary embodiment of the wet disk brake is characterized in that the inlet grooves, radially on the outside relative to the friction surface, have a groove width that is at least thirty percent greater than a groove width of the circumferential groove. A dimension of the respective groove transverse to its length is referred to as the groove width. Accordingly, the groove width of the inlet grooves extends essentially perpendicular to the groove width of the circumferential groove. The significantly larger groove width of the inlet further improves the oil supply from the outside into the circumferential groove.

Another preferred exemplary embodiment of the wet disk brake is characterized in that the circumferential groove is closed radially on the inside relative to the friction surface. This means that no grooves extend radially inwards from the circumferential groove. This can be achieved, for example, with a piece of friction lining that is designed as a closed inner ring.

A further preferred exemplary embodiment of the wet disk brake is characterized in that the circumferential groove has a blind groove between two inlet grooves radially on the inside relative to the friction surface. The blind grooves are preferably each arranged radially inside or below the outer friction lining pieces. The cooling oil is better distributed over the friction surface due to the blind grooves. In addition, the blind grooves increase the area of contact area with an adjacent steel disk for convective heat transfer. In addition, the proportion of material on the inner diameter of the circumferential groove can be reduced. This results in a homogeneous surface pressure distribution during operation.

A further preferred exemplary embodiment of the wet disk brake is characterized in that the blind groove has the shape of a rectangle. These blind grooves can be produced simply and inexpensively in terms of manufacturing technology.

Another preferred exemplary embodiment of the wet disk brake is characterized in that the blind groove has the shape of a semicircle. As a result, the service life of the friction lining pieces which delimit the circumferential groove radially on the inside can advantageously be prolonged.

Another preferred exemplary embodiment of the wet disk brake is characterized in that the blind groove is essentially V-shaped. The blind grooves in the friction surface can all be of the same design. Depending on the design, however, it can also be advantageous to combine blind grooves of different shapes with one another in one friction surface.

A further preferred exemplary embodiment of the wet disk brake is characterized in that the friction surface has, in addition to the circumferential groove, at least one further zigzag-shaped or undulating groove running around the circumference and/or at least one further groove running tangentially around the circumference. This can further improve the cooling effect in the externally oiled, wet disk brake.

Further advantages and advantageous configurations of the invention are the subject of the following figures and their description.

Specifically:

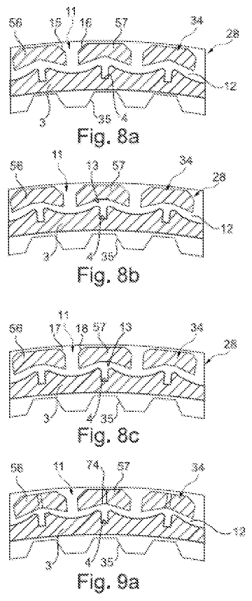

FIG. 1 Prior art: Common grooving of friction linings
(literature source: Naunheimer et al., Fahrgezeuggetriebe [Vehicle transmissions]: Grundlagen, Auswahl, Auslegung und Konstruktion [Principles, selection, design and construction], FIG. 8.59 Common grooving of friction linings (ZF), p. 393, 2019, ISBN 978-3-662-58882-6).

FIG. 2 Wet disk brake with external oiling.
Generally: Lubrication systems of wet disk clutches/brakes
Schematic diagram of a wet disk brake with external oiling.

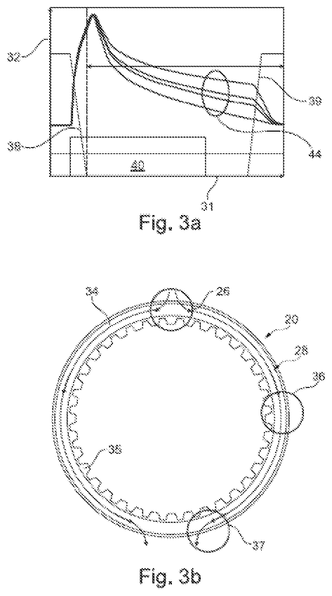

FIG. 3 Friction disk with external oiling (brake): Oil routing and cooling
Shift of a disk brake: Schematic temperature course
Requirement: Oil routing and cooling when brake is closed.

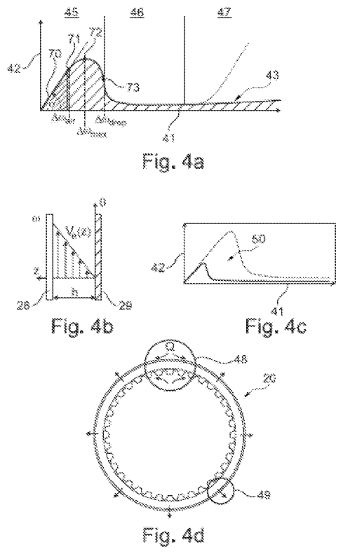

FIG. 4 Friction disk with external oiling (brake): Drag losses
Generally: Drag torques of disk clutches/brakes
Requirement: Oil removal when the brake is open.

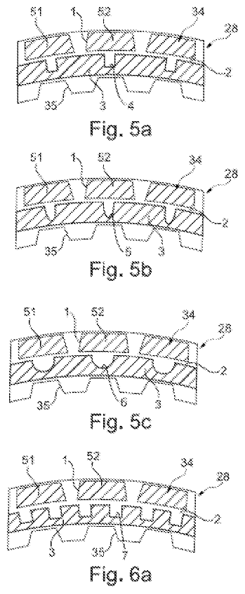

FIGS. 5, 6, 7 Friction disk with external oiling (brake: Groove pattern variant 1 Variations a, b, c, d, e, f, g, h.

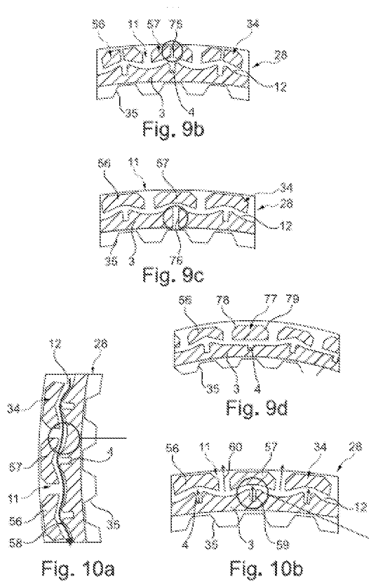

FIGS. 8, 9 Friction disk with external oiling (brake): Groove pattern variant 2 Variations i, j, k, I, m, n, o.

FIG. 10 Friction disk with external oiling (brake): Groove pattern
Example: Schematic cooling oil flow when closed
Example: Schematic de-oiling & separation behavior when open.

Various known groove patterns 62 to 69 are shown in plan view in FIG. 1. A friction disk with a friction surface equipped without grooves is labeled 61. The friction disk has inner toothing teeth radially on the inside for hanging the friction disk in a disk carrier (not shown).

The groove pattern 62 comprises radial grooves. The groove pattern 63 comprises cross slots. The groove pattern 64 comprises parallel grooves arranged in groups. The groove pattern 65 comprises blind grooves arranged crosswise. The groove pattern 66 comprises spiral grooves. Groove pattern 67 comprises intersecting grooves. The groove pattern 68 comprises sunburst grooves. The groove pattern 69 comprises an annular groove with pressure relief holes.

The groove patterns are used to cool the disks with a flow of oil, even when the shifting element is closed. In addition, the grooves serve to cut the oil film and thereby stabilize the friction coefficient. In this way, a desired friction behavior is created in a shift. When the shifting element is open, the drag torque can be influenced and reduced by the grooves.

In FIGS. 2a and 2b, a wet disk brake 20 is shown schematically in different views. FIG. 2a shows various lubrication systems 21, 22 and 23 of wet disk clutches or disk brakes. Lubrication systems 21 to 23 can be implemented differently for wet disk clutches and brakes, depending on the application.

In general, the cooling oil of the friction systems is supplied from the inside either actively, for example in the case of double clutches with pressure oiling, or passively, for example in shifting elements in stepped automatic transmissions with passive oil distribution in the transmission, as illustrated by an arrow 24 and a double arrow 25. Depending on the design of the transmission, the friction system can also be operated in an oil bath, as suggested at 23. In the special case of disk brakes, such as those used in stepped automatic transmissions, hybrid transmissions or e-axles, active oiling from the outside can be useful, as indicated by an arrow 26 at 22.

An arrow in FIG. 2b indicates that an inner disk carrier 27 of the wet disk brake 20 rotates at a speed w. One of a total of four friction disks 28 is suspended in the inner disk carrier 27. The friction disks 28 are connected to the inner disk carrier 27 in a torque-proof manner by means of a corresponding internal toothing.

The friction disks 28 are each arranged axially between two steel disks 29 which are connected in a torque-proof manner to an outer disk carrier 30 of the wet disk brake 20. Arrows rᵢ and rₐ indicate an inner radius and an outer radius of annular disk-like friction surfaces between the steel disks 29 and the friction disks 28 when the wet disk brake 20 is closed. An arrow h in FIG. 2b shows that the steel disks 29 are spaced apart from the friction disks 28 in the axial direction when the disk brake 20 is open.

The term axial refers to an axis of rotation 33 of the wet disk clutch 20.

Disk brakes are generally used as internal shifting elements for shifting under load in planetary gear transmissions. Wet disk brakes 20, as shown in FIGS. 2a and 2b, are used in automatic transmissions, DHT transmissions and/or in multi-speed e-axles.

FIG. 3b shows the wet disk brake 20 in a plan view of a friction disk 28. In a circle 26, arrows indicate an oil supply from the outside for cooling the disk brake 20 in the closed state. In a circle 36, it is shown that the aim is a suitable groove pattern for directing a flow of cooling oil along the circumference of the friction ring to enable complete, uniform and effective convective cooling of the friction system after a shifting event. An exit of the cooling oil is indicated by a circle 37. The flow of cooling oil should exit at the lowest point of the friction system, as far as possible. A premature outflow of the cooling oil on the inner diameter at the oil entry point and/or along the circumference on the outer diameter should be prevented or minimized.

The friction disk 28 is equipped with a friction surface 34 and inner toothing 35. A desired groove pattern is provided in friction surface 34.

A Cartesian coordinate diagram with an x-axis 31 and a y-axis 32 is shown in FIG. 3a. A time in a suitable time unit is plotted on the x-axis 31. A temperature or a rotational speed is plotted on the y-axis 32 in a suitable unit in each case. In a rectangle 40, the disk brake is closed. To the right of the rectangle 40, the disk brake is open. 38 illustrates a speed drop on closing of the disk brake. 39 illustrates a speed increase on opening of the disk brake. In an ellipse 44, non-uniform temperature distributions can be seen on the circumference of the disk brake due to non-uniform cooling oil distribution. When the brake is closed, the friction disks and the steel disks in the disk pack of the disk brake are pressed together.

A Cartesian coordinate diagram with an x-axis 41 and a y-axis 42 is shown in FIG. 4a. A speed difference is plotted on the x-axis 41 in a suitable speed unit. A drag torque is plotted on the y-axis 42 in a suitable unit. A curve 43 shows a drag torque curve in different sections 45, 46 and 47. There is a linear course 70 up to a point 71. After a maximum 72 there is a drop 73 in the drag torque course. A dotted line indicates relative movements, in particular wobbling movements of the disks, which lead to a renewed increase in the drag torque.

A shear flow of the oil between a friction disk 28 and a steel disk 29 is indicated in FIG. 4b. A shift 50 of an air intake to low speeds is indicated in FIG. 4c. A suitable groove pattern is intended to improve the de-oiling of the brake and thus the drag losses.

A circle 48 in FIG. 4d indicates that oiling when the disk brake 20 is open should be reduced or minimized as far as possible, namely advantageously by means of a suitable groove pattern. In a circle 49, de-oiling is indicated by an arrow. When the disk brake 20 is open, rapid de-oiling/spinning free is desirable. Both the separation of the disks and the de-oiling can be assisted by the groove pattern.

FIGS. 5 to 9 each show a section of a friction disk 28 with inlet grooves 1; 11 and a circumferential groove 2; 12 in different groove patterns. The groove patterns of FIGS. 5a, 5b, 5c; 6a, 6c; 7; 8a, 8b, 8c; 9a, 9b, 9c encompass a closed inner ring 3. That is, the circumferential groove 2; 12 is closed radially on the inside in these exemplary embodiments.

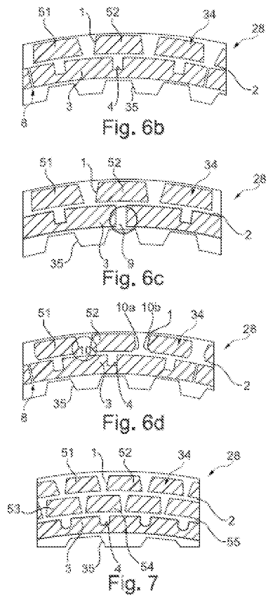

An inlet groove 1 is bounded by two friction lining pieces 51, 52 in each case. The friction lining pieces 51, 52 are trapezoidal in shape. The trapezoidal shape of the outer friction lining pieces 51, 52, which are also referred to as pads, means that the inlet groove 1 opens from the inside to the outside, as in a diffuser. The illustrated width of the inlet grooves facilitates the oil supply from the outside when the disk brake is in the closed state. In FIGS. 5a to 5c and 6a to 6d, as well as in FIG. 7, the circumferential groove 2 extends in the tangential direction. The tangential groove 2 is arranged centrally to distribute the cooling oil over the circumference of the friction system. The closed inner ring 3 prevents the cooling oil from flowing away from the friction contact.

In FIG. 5a the closed inner ring 3 is equipped with a rectangular blind groove 4. The rectangular blind grooves 4 are arranged below the outer row of pads 51, 52 and lead to better distribution of the cooling oil and also enlarge the contact surface for the convective heat transfer between cooling oil and steel disk. At the same time, the proportion of material on the inner diameter can be reduced. This results in a homogeneous surface pressure distribution.

It is indicated in FIG. 5b that the inner ring 3 can also be equipped with V-shaped blind grooves 5. It is indicated in FIG. 5c that the closed inner ring 3 can also be equipped with blind grooves 6 in the shape of a crescent or semicircle.

In FIG. 6a, the number and the position of blind grooves 7 has changed compared with the exemplary embodiments of FIGS. 5a to 5c. Two or more rectangular blind grooves 7 are each arranged under one of the friction lining pieces 51, 52. In addition, the blind groove 7 is arranged offset instead of centrally under the outer pad 52.

A radial groove 8 in the inner ring 3 is shown in FIG. 6b. The result of the radial grooves 8 is that the inner ring 3 is no longer closed but interrupted or segmented. Through a small segmentation of the inner ring 3, for example into six or eight segments, the waste of material in production can be reduced.

In FIG. 6c, a radial groove 9 is shown in the inner ring 3, which is wider than in FIG. 6b. The radial groove 9 is arranged below or radially inside the friction lining piece 52.

In FIG. 6d, 10 shows the friction lining pieces 51, 52 are provided with additional chamfers or bevels 10a, 10b at the edges.

FIG. 7 shows a groove pattern with multiple rows of trapezoidal outer pads or friction lining pieces 51, 52 and 53, 54, which are staggered. This results in a further circumferential groove 55 in addition to the circumferential groove 2.

FIGS. 8a to 8c and 9a to 9c show groove patterns with external pads or pieces of friction lining 56, 57, which are equipped with chamfers or bevels 15, 16 facing one another. This results in a funnel-shaped opening to the outside in the inlet groove 11. In addition, the friction lining pieces 56, 57 and the closed inner ring 3 are designed and arranged in such a way that a curved zigzag shape results in the circumferential groove 12. This results in better cooling oil flow through the circumference. The contact pattern is also improved, resulting in less wear. In combination with an oil reservoir in the rectangular blind groove 4 in the open state, with rotation of the friction disk, the cooling oil penetrates to the outside and generates an increase in pressure in the lubrication gap. If there is no corrugation in the carrier sheet, this can lead to improved separation behavior. In this way, the drag torque can be effectively reduced.

In FIG. 8b, the friction lining pad 57 is provided with a flattening 13, in contrast to the pointed design in FIG. 8. The flattening 30, like the point in FIG. 8a, is arranged radially in the center on the friction lining piece 57.

In FIG. 8c, the friction lining pieces 56 and 57 are provided with rounded contours 17, 18 facing one another to show the widening of the inlet groove 11 radially on the outside.

In FIG. 9a, the friction lining pieces 56, 57 are each provided with an impressed radial groove 74, in contrast to FIG. 8a. This helps the oil reservoir to be drained of oil or spun free from the blind groove 4. The number of radial grooves 74 can differ from the number of friction lining pieces 56, 57. The groove depth and the groove width of the impressed radial groove 74 are smaller than in the blind groove 4.

In FIG. 9b, the friction lining pieces 56, 57 are each segmented by a radial groove 75. Otherwise, FIG. 9b is the same as FIG. 8b.

The closed inner ring 3 is segmented by a radial groove 76 in FIG. 9c. Otherwise, the inner ring 3 is the same as the inner ring of FIG. 8b. The friction lining pieces 56, 57 in FIG. 9c are the same as the friction lining pieces 56, 57 in FIG. 8a.

In FIG. 9d, the friction lining pieces 56 are arranged to alternate with the friction lining pieces 77. The friction lining piece 77 has the shape of a rectangle with bevels 78, 79.

The cooling oil distribution in the circumferential groove 12 is indicated by an arrow 58 in FIG. 10a. The cooling oil flow can be kept in the friction system by the closed or slightly segmented inner ring 3 and the curved tangential groove 12. Outflow and inflow can be minimized. FIG. 10a shows a schematic flow of cooling oil when the disk brake is closed.

In FIG. 10b, arrows 59 and 60 indicate schematic de-oiling and separation behavior in the open state. The blind grooves 4 result in a lubrication wedge effect. An oil reservoir in the blind groove 4 in the open state with rotation of the friction disk pushes outwards and generates an increase in pressure in the lubrication gap. Optimum distribution of the disks when the clutch or brake is open results in a reduction in drag torque. Furthermore, the clutch can be gently closed when it is actuated. Arrows 60 indicate a flow of the oil radially outwards through the inlet grooves 11.

Cooling when Closed (No Rotation) (FIG. 3, FIG. 10):

The design of the groove pattern facilitates the cooling oil supply from the outside by means of a low flow resistance, and a targeted oil flow minimizes early outflow of the cooling oil from the friction system on the one hand and enables uniform cooling over the circumference of the friction system on the other (improvement of convective cooling). This can improve the thermal economy of the shifting element and reduce the cooling times.

Drag Losses when Open (FIG. 4, FIG. 10):

By making allowances for the interrelationships of air intake/separation behavior and their effect on drag losses, the design of the groove pattern (influencing the pressure level/distribution in the lubrication gap) can minimize drag losses. At the same time, additional passive oiling of the friction system from the inside of the transmission is reduced. This supports the goal of a low-loss disk brake as a starting, shifting and separating element for hybrid modules, DHT and e-axles.

### Groove Pattern Variant 1 (FIG. 5, FIG. 6, FIG. 7):

External trapezoidal pads, groove 1 open from the inside to the outside (diffuser). Wide groove channels facilitate the oil supply from the outside when the brake is closed. Tangential groove 2 arranged in the middle to distribute the cooling oil over the circumference of the friction system. The closed inner ring 3 prevents the cooling oil from flowing away from the friction contact. The rectangular blind grooves 4 are arranged below the outer row of pads and lead to better distribution of the cooling oil and enlarge the contact surface for convective heat transfer (cooling oil/steel disk). At the same time, the proportion of material on the inner diameter can be reduced (homogeneous surface pressure distribution).

### Groove Pattern Variant 2 (FIG. 8, FIG. 9):

External pads with chamfer or opening groove to the outside (11 funnel shape). Curved zigzag groove 12 instead of tangential groove for better cooling oil flow around the circumference. The contact pattern is also improved (less wear). In combination with an oil reservoir in the blind groove in the open state with rotation of the friction disk, the cooling oil pushes outwards and creates an increase in pressure in the lubrication gap. If there is no corrugation in the carrier plate, this can lead to improved separation behavior of the disks (reduction of the drag torque).

### LIST OF REFERENCE SYMBOLS

1 Inlet groove
2 Circumferential groove
3 Closed inner ring
4 Blind groove
5 Blind groove
6 Blind groove
7 Blind groove
8 Groove (radial)
9 Groove (radial)
10a, b Bevel, chamfer
11 Inlet groove
12 Circumferential groove
13 Flattening
15 Bevel, chamfer
16 Bevel, chamfer
17 Rounding
18 Rounding
19 Corner
20 Disk brake
21 Lubrication system
22 Lubrication system
23 Lubrication system
24 Arrow
25 Double arrow
26 Arrow (external oiling)
27 Inner disk carrier
28 Friction disk
29 Steel disk
30 Outer disk carrier
31 x-axis
32 y-axis
33 Axis of rotation
34 Friction surface
35 Inner toothing
36 Circle
37 Circle
38 Speed drop
39 Speed increase
40 Rectangle
41 x-axis
42 y-axis
43 Curve
44 Temperature distribution
45 Section
46 Section
47 Section
48 Circle
49 Circle
50 Shift
51 Friction lining piece
52 Friction lining piece
53 Friction lining piece
54 Friction lining piece
55 Circumferential groove
56 Friction lining piece
57 Friction lining piece
58 Arrow
59 Arrow
60 Arrow
61 Groove pattern
62 Groove pattern
63 Groove pattern
64 Groove pattern
65 Groove pattern
66 Groove pattern
67 Groove pattern
68 Groove pattern
69 Groove pattern
70 Linear course
71 Point
72 Maximum
73 Drop
74 Radial groove
75 Radial groove
76 Radial groove
77 Friction lining area
78 Bevels
79 Bevels

1. A wet disk brake with external oiling of a friction surface, having a circumference, wherein the friction surface has a groove running around the circumference in a zigzag or undulating shape or a groove running tangentially around the circumference.

2. The wet disk brake according to claim 1, wherein inlet grooves through which oil enters the circumferential groove from the outside each have a widening radially on the outside relative to the friction surface.

3. The wet disk brake according to claim 1, wherein friction lining pieces, which delimit the circumferential groove radially on the outside and the inlet grooves in the circumferential direction, are trapezoidal in shape in order to constitute a diffuser-like widening of the inlet groove.

4. The wet disk brake according to claim 1, wherein friction lining pieces which delimit the circumferential groove radially on the outside and the inlet grooves in the circumferential direction, have bevels or chamfers facing one another in the circumferential direction to constitute a funnel-like widening of the inlet groove radially on the outside.

5. The wet disk brake according to claim 1, wherein the inlet grooves, radially on the outside relative to the friction surface, have a groove width which is at least thirty percent greater than a groove width of the circumferential groove.

6. The wet disk brake according to claim 1, wherein the circumferential groove is closed radially on the inside relative to the friction surface.

7. The wet disk brake according to claim 1, wherein the circumferential groove has a blind groove between two inlet grooves radially on the inside relative to the friction surface.

8. The wet disk brake according to claim 7, wherein the blind groove has the shape of a rectangle.

9. The wet disk brake according to claim 7, wherein the blind groove has the shape of a semicircle.

10. The wet disk brake according to claim 1, wherein the friction surface, in addition to the circumferential groove, has:
at least one further zigzag-shaped or undulating groove running around the circumference, or
at least one further groove running tangentially around the circumference.

11. A wet disk brake, comprising:
a circumference; and
a friction surface arranged for receiving an external oiling, the friction surface comprising:
a circumferential groove:
running around the circumference in a zigzag shape or an undulating shape; or
running tangentially around the circumference.

12. The wet disk brake of claim 11, wherein:
the friction surface further comprises an inlet groove arranged to channel the external oiling from a radial outside of the friction surface to the circumferential groove; and
the inlet groove comprises a widening at the radial outside.

13. The wet disk brake of claim 12, wherein the friction surface is at least partially formed from individual trapezoidal-shaped friction lining pieces arranged to:
delimit a radial outer edge of the circumferential groove; and
form the widening of the inlet groove.

14. The wet disk brake of claim 12, wherein:
the friction surface is at least partially formed by individual friction lining pieces arranged to:
delimit a radial outer edge of the circumferential groove; and
form the inlet groove; and
the individual friction lining pieces comprise respective bevels or chamfers facing one another that form the widening of the inlet groove.

15. The wet disk brake of claim 12, wherein a width of the inlet groove at the radial outside is at least thirty percent (30%) greater than a width of the circumferential groove.

16. The wet disk brake of claim 11, wherein the circumferential groove is closed on a radial inside of the circumferential groove.

17. The wet disk brake of claim 12, wherein:
the friction surface further comprises a second inlet groove arranged to channel the external oiling from the radial outside to the circumferential groove;
the circumferential groove comprises a blind groove arranged between the inlet groove and the second inlet groove; and
the blind groove is disposed on a radial inside of the circumferential groove.

18. The wet disk brake of claim 17, wherein the blind groove is shaped as a rectangle.

19. The wet disk brake of claim 17, wherein the blind groove is shaped as a semicircle.

20. The wet disk brake of claim 11, wherein the friction surface further comprises:
a second circumferential groove:
running around the circumference in a zigzag shape or an undulating shape; or
running tangentially around the circumference.
